(19) United States
(12) Patent Application Publication
(10) Pub. No.: US 2013/0309554 A1
(43) Pub. Date: Nov. 21, 2013

(54) LEAD-ACID BATTERY WITH HIGH SPECIFIC POWER AND SPECIFIC ENERGY

(71) Applicants: Subhash K. DHAR, Bloomfield Hills, MI (US); Fabio ALBANO, Royal Oak, MI (US); William KOETTING, Davisburg, MI (US)

(72) Inventors: Subhash K. DHAR, Bloomfield Hills, MI (US); Fabio ALBANO, Royal Oak, MI (US); William KOETTING, Davisburg, MI (US)

(73) Assignee: Energy Power Systems, LLC, Troy, MI (US)

(21) Appl. No.: 13/842,777

(22) Filed: Mar. 15, 2013

Related U.S. Application Data
(63) Continuation-in-part of application No. 13/475,484, filed on May 18, 2012.

(51) Int. Cl. H01M 10/06

(52) U.S. Cl. CPC H01M 10/06
USPC 429/160; 429/225; 429/149

(57) ABSTRACT

The present disclosure includes a lead-acid battery having higher specific power and specific energy than prior known lead-acid batteries. A lead-acid electrochemical storage device is provided, comprising a specific power of between about 650 and about 3,050 Watts/kilogram; and a specific energy of between about 10 and about 80 Watt-hours/kilogram. In some embodiments, the device has a cycle life of greater than 150 cycles and is adapted for use in a vehicle application. The application comprises stop/start or the partial or complete electrification of the vehicle propulsion system. The device may have a bipolar or pseudo-bipolar design, multiple cells disposed within a common casing, and the cells are connected ionically within each cell and electronically between cells.

### RELATED APPLICATIONS

This application is a continuation-in-part of, and claims priority to, U.S. patent application Ser. No. 13/475,484, entitled Lead-Acid Battery with High Power Density and Energy Density, filed May 18, 2012, by Subhash Dhar, et al. This application incorporates by reference the entire disclosure of U.S. application Ser. No. 13/350,505, entitled, “Improved Substrate for Electrode of Electrochemical Cell,” filed Jan. 13, 2012, by Subhash Dhar, et al., the entire disclosure of U.S. application Ser. No. 13/350,686, entitled, “Lead-Acid Battery Design Having Versatile Form Factor,” filed Jan. 13, 2012, by Subhash Dhar, et al., the entire disclosure of U.S. patent application Ser. No. 13/475,484, entitled “Lead-Acid Battery with High Power Density and High Energy Density,” filed May 18, 2012, by Subhash Dhar, et al., and the entire disclosure of U.S. patent application Ser. No. 13/626,426, entitled “Lead-Acid Battery Design Having Versatile Form Factor,” filed Sep. 25, 2012, by Subhash Dhar, et al., the entire disclosure of U.S. patent application Ser. No. 13/588,623, entitled “Improved Active Materials for Lead Acid Battery,” filed Aug. 17, 2012, by Subhash Dhar, et al., and the entire disclosure of U.S. patent application Ser. No. ______/______,______, entitled “Metallic Alloys Having Amorphous, Nanocrystalline, or Microcrystalline Structure,” filed contemporaneously with this application.

### TECHNICAL FIELD

The present disclosure relates generally to improved lead-acid electrochemical cells, batteries, modules, and battery systems. Embodiments of the present disclosure may be used for vehicle propulsion for electric and hybrid-electric vehicles as well as for stationary power applications, and other applications in which high specific power and specific energy are desired. More particularly, embodiments of the present disclosure relate to lead-acid electrochemical cells, batteries, modules, and systems having improved specific power and specific energy.

### BACKGROUND

Lead-acid electrochemical cells have been commercially successful as power cells for over one hundred years. For example, lead-acid batteries are widely used for starting, lighting, and ignition (“SLI”) applications in the automotive industry.

As an alternative to lead-acid batteries, nickel-metal hydride (“Ni-MH”) and lithium-ion (“Li-ion”) batteries have been used for electric and hybrid-electric vehicle applications. Despite their higher cost, Ni-MH and Li-ion electro-chemistries have been favored over lead-acid electrochemistry for these applications due to their higher specific energy and energy density compared to prior known lead-acid batteries. Conventional lead-acid batteries suffer from low specific energy, due primarily to the weight of the components.

There remains a need for specific applications in which partial electrification of the vehicle may provide environmental and energy-efficiency advantages, without the same level of cost associated with hybrid and electric vehicles using Ni-MH and Li-ion batteries. Even more specifically, there is a need for a low cost, energy efficient battery in the area of start/stop automotive applications.

Conventional lead-acid batteries have not yet been able to satisfy this need. Conventional lead-acid batteries have been designed and optimized specifically for SLI operation. The needs of a micro- and mild-hybrid application are different. The state of charge and depth of discharge in these two situations are different. When starting an engine, the battery is fully-charged. While the energy demands of starting are minimal, the power demands are substantial. A typical automotive battery is subject to ambient temperature extremes, which may add additional stress. At high ambient temperatures, the acid electrolyte may attack battery components; at low ambient temperatures (cold-cranking), the battery may not be able to deliver sufficient power. Traditionally, lead-acid batteries were designed to provide power at low temperature. This resulted in relatively low-energy designs. A typical design criterion would be to provide a 300 A pulse for starting a car, at low temperature (i.e., −20 degrees), maintaining the voltage above about 8 volts. More recently, manufacturers are beginning to make higher energy and higher power lead-acid batteries.

A battery for a hybrid vehicle is typically operated at an intermediate state of charge. It is more difficult to withdraw the same amount of current from a battery at an intermediate state of charge than it is from a fully-charged battery. A solid-electrolyte interface develops at the positive and negative electrodes which slows down the kinetics of the chemical reactions at the electrodes. Within the electrodes, charge is non-uniformly distributed which further slows down the chemical reactions.

Fully electric vehicles are considered “charge depleting.” The storage system is charged and drained as the vehicle is operated. Hybrid electric vehicle applications, including micro- and mild-hybrid applications, on the other hand, are considered “charge sustaining,” as the storage system may be recharged during operation. A key requirement for hybrid electric vehicle (“HEV”) systems is that the energy storage system provides high peak power combined with high energy density, while at the same time accepting high regenerative braking currents at high efficiency. The duty cycle of a peak power application requires exceptional cycle life at low depths of discharge, particularly in charge-depleting systems.

Hybrid vehicles also have different requirements of the energy storage system compared to those for purely electric vehicles. Range is the critical factor for a practical electric vehicle, making energy density an important parameter. Power and cycle life are important, but they are secondary to energy density for a fully electric vehicle.

In hybrid electric vehicle applications, specific power density may be the primary consideration. Good cycle life from 30% to 60% depth-of-discharge is also more important than is cycle life at 80% depth-of-discharge in electric vehicle applications. Similarly, rapid recharge may be important to allow efficient regenerative braking. And charge/discharge efficiency may be important to maintain battery state-of-charge in the absence of external charging. Thermal management and excellent gas recombination may be important secondary considerations.

The capability to deliver power at a specific rate and intermediate state of charge is important in certain hybrid applications. Various duty cycles demand different ranges of power and energy. This translates to requirements for efficiency and cycle life. The efficiency of state of the art lead-acid batteries is in the range of 70% to 75%, or less. Their cycle life is typically substantially less than 1,000 and in most cases less than 500 cycles under the demands of a hybrid duty cycle. For example, USABC reports minimum goals for long-term commercialization of hybrid and electric vehicle batteries. Table 1 presents a set of parameters that are generally accepted goals or requirements for various hybrid applications based on guidelines from the U.S. Department of Energy.

TABLE 1

| | | | | | | | Strong | | | | | | | |
|---|---|---|---|---|---|---|---|---|---|---|---|---|---|---|
| | | | | | Mild | | Hybrid | | PHEV | | | | | |
| | Start/Stop | | Regeneration | | Hybrid | | (HEV) | | (<10 kWhr) | | EREV | | EV | |
| Power | 4-6 | kW | 6-20 | Kw | 6-20 | kW | >20 | kW | >50 | kW | >100 | kW | >100 | kW |
| Energy | <0.5 | kWhr | <1.0 | kWhr | 0.5-1.0 | kWhr | 1-2 | kWhr | 4-8 | kWhr | 10-25 | kWhr | >25 | kWhr |

| | | | | | | | |
|---|---|---|---|---|---|---|---|
| Cycle | >300,000 | >300,000 | >300,000 | >300,000 | >1,000 | >1,000 | >1,000 |
| Life | | | | | | | |
| Efficiency | >80% | >80% | >80% | >90% | >90% | >90% | >90% |

“Swing” is the difference between the state of charge at beginning and end of discharge. An SLI battery typically experiences a swing of 2% resulting in a depth of discharge of about 2%. The swing of hybrid operation is typically only about 5%. But because the hybrid battery may be starting at a state-of-charge well below 100%, the depth-of-discharge in a hybrid mode is typically higher and may be substantially higher. The kinetics discussed above made it harder to withdraw additional charge from the battery.

Further, operation in this range requires accessing portions of the active material that may not be involved in SLI operation. As the battery discharges, grains of PbSO₄ form in the pores. Upon charging, these grains dissolve. With continued discharge, however, the PbSO₄ grains grow larger. At extreme levels of discharge, these PbSO₄ grains may clog the pores of the active material and become insoluble rendering portions of the active material inaccessible and unusable. Thus, hybrid operation may be more likely to damage the electrode active material than SLI operation.

These factors impair charge acceptance. Conventional lead-acid batteries are not formulated to address these challenges. A new process, design, and production process needs to be developed and optimized for micro- and mild-hybrid applications.

One need for micro- and mild-hybrid applications is for a low-cost and low-weight battery. NiHM and Li-ion batteries are relatively high cost and conventional lead-acid batteries are relatively heavy. This added weight causes the lead-acid battery to have a lower specific energy due to the substantially higher weight of the lead components and other structural components that are necessary to provide rigidity to the plates.

SLI lead-acid batteries typically have thinner plates, providing increased surface area needed to produce the power necessary to start the engine. But the grid thickness is limited to a minimum useful thickness because of the casting process and the mechanics of grid hang. Plates are also designed with a substantial excess of active material that is sacrificed as the active material and current collector corrode during the life of the cell.

Conventional positive plates are rarely less than 0.08″ (main outside framing wires) and 0.05″ on the face wires because of the difficulties of casting at production rates and, more importantly, concern over poor cycle-life issues. These parameters limit power. Lead-acid batteries designed for deeper discharge applications (such as motive power for forklifts) typically have heavier plates to enable them to withstand the deeper depth of discharge in these applications.

Another need for micro- and mild-hybrid applications is that rechargeable batteries should be able to be charged and discharged with less than 0.001% energy loss at each cycle. This is a function of the internal resistance of the design and the overvoltage necessary to overcome it. The reaction preferably is energy-efficient and involves minimal physical changes to the battery that might limit cycle-life. It is desirable to reduce side chemical reactions that may deteriorate the cell components, cause loss of life, create gaseous byproducts, or cause loss of energy. In addition, a rechargeable battery desirably has high specific energy, low resistance, and good performance over a wide range of temperatures and is able to mitigate the structural stresses caused by lattice expansion. When the design is optimized for minimum resistance, the charge and discharge efficiency may dramatically improve.

Lead-acid batteries have many of these characteristics. The charge-discharge process is essentially highly reversible. The lead-acid system has been extensively studied and the secondary chemical reactions have been identified. And their detrimental effects have been mitigated using catalyst materials or engineering approaches. Although its energy density and specific energy are relatively low, the lead-acid battery performs reliably over a wide range of temperatures, with good performance and good cycle life. A primary advantage of lead-acid batteries remains their low-cost.

A number of improvements have been made in the basic design of lead-acid electrochemical cells. Many of these improvements involve the characteristics of the substrate, the active material, as well as the bus bars or current collector elements. For example, a variety of fibers or metals have been added to or embedded in the substrate material to help strengthen it. The active material has been strengthened with a variety of materials, including synthetic fibers and other additions. Yet, particularly with respect to lead-acid batteries, these various approaches represent a trade-off between durability, capacity, and specific energy. The addition of these various non-conductive strengthening elements helps strengthen the supporting grid but replaces conductive substrate and active material with non-conductive components.

A Ragone plot, such as the one in FIG. 1, shows various types of electrochemical cells along with their respective specific powers and specific energies. FIG. 4 depicts the performance of a design over a full range of conditions, based on repeatedly discharging cells, typically at a 3-5 set rate (Amp.) condition, at different C (capacity) rates, for example, C/10, C/6, 1C, 10C, and 20C. Measured Ampere-hour capacities are used to calculate a Peukert constant. Performance at other discharge rates are predicted based on the Peukert equation:

C_{y}−I^{k}^{ₜ}

Where C=capacity, I=discharge current, t=discharge time, and k is the constant determined from the measurements.

Peukert's law can be written as:

$$IT = {C ( \frac{C}{IH} )}^{k - 1}$$

Where “It” is the effective capacity at the discharge rate I down to a point where cell voltage falls rapidly. Where the capacity is listed for two discharge rates, the Peukert exponent can be determined algebraically. For higher C-rates the end voltages change to compensate for the IR voltage loss. Specifically, as the rate goes up the cut off voltage go down. For example, for every 5C beyond 1C, the cell voltage cut off falls by about 200 mV. Power is determined at the midpoint voltage for high rate discharge. These powers are also determined at different states-of-charge 100%, 80%, 60%, 40%, and 30%, for both discharge and charge. The immediate charge/discharge history may affect these values, as does temperature.

FIG. 4 depicts Peukert Curve, which along with the accompanying discussion, above, illustrates one method of calculating power in accordance with some embodiments. In particular, FIG. 4 shows the changes in voltage and in current at various discharge rates, namely, C/5 ad C/10, showing the voltage and current obtained at these rates. The x-axis in FIG. 4 depicts time in arbitrary units of time. The y-axis depicts both voltage in Volts and current in Amps. The uppermost two curves depict voltage at C/5 and C/10 discharge rates and the lower two curves depict the respective currents of 8 A (C/5) and 4 A (C/10) discharge rates.

### SUMMARY

The present disclosure includes a lead-acid battery having higher specific power and specific energy than prior known lead-acid batteries. In some embodiments, a lead-acid electrochemical storage device is provided, comprising a specific power above about 620 W/kg. Alternatively, some embodiments comprise specific power between about 550 and about 3,000 W/kg and specific energy between about 15 and about 80 Wh/kg. In some embodiments, the device has a cycle life of greater than 150 cycles and is adapted for use in a vehicle or stationary power application. Suitable applications may comprise stop/start or the partial or complete electrification of a vehicle propulsion system. The device may have a bipolar or pseudo-bipolar design, multiple cells disposed within a common casing, and the cells are connected ionically within each cell and electronically between cells.

Additional objects and advantages of the disclosure will be set forth in part in the description which follows, and in part will be apparent from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiments of the disclosure and together with the description, serve to explain the principles of the disclosure.

### BRIEF DESCRIPTION OF THE DRAWINGS

FIG. 1 is a Ragone plot of the range of specific power and specific energy of various prior known energy storage systems and an internal combustion engine.

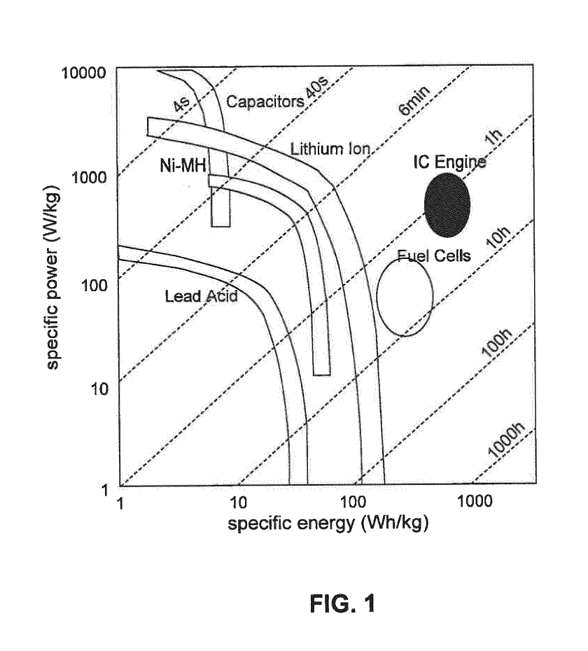

FIG. 2 is a Ragone plot of the range of specific power and specific energy of various prior known energy storage systems, an internal combustion engine, and certain embodiments of the present disclosure.

FIG. 3 is a graph of the theoretical relationship between cell voltage as a function of current for prior known typical lead-acid batteries depicting losses due to internal resistance, activation polarization, and concentration polarization.

FIG. 4 is a series of discharge curves of voltage as a function of time for various C rates for embodiments of the present disclosure.

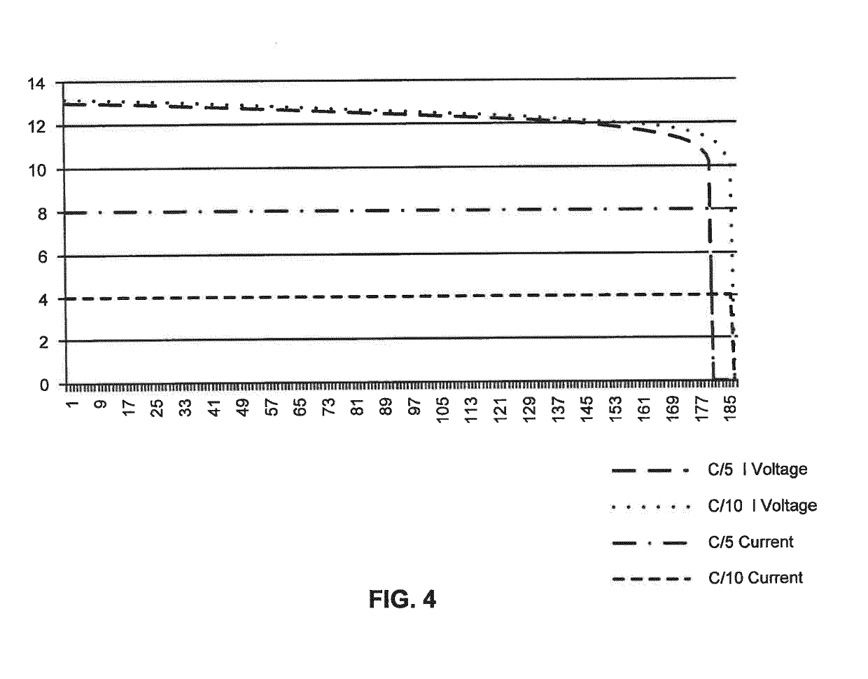

FIG. 5 is a graph of power as a function of energy for representative prior known lead-acid battery samples identified in the present disclosure.

FIG. 6 is a graph of power as a function of energy depicting the range of energy and power that has been achieved by prior known lead-acid batteries, along with a linear trendline describing the line of best fit to the points depicted in FIG. 5.

FIG. 7 is a graph of power as a function of energy depicting the range of energy and power that has been achieved by prior known lead-acid batteries, along with a linear trendline describing the line of best fit to the points depicted in FIG. 5, and a second trendline translated to intercept the position of a prior known lead-acid battery.

FIG. 8 is a schematic diagram of the change in aspect ratio of electrodes of an embodiment of the present disclosure.

FIG. 9 is a schematic diagram of a bus bar of an embodiment of the present disclosure.

FIG. 10 is a schematic isometric view of a portion of a lead-acid electrochemical cell with a plurality of electrode assemblies in a stacked configuration according to another embodiment of the present disclosure.

FIG. 11 is a schematic isometric view of the lead-acid electrochemical cell of FIG. 10 connected to a power bus.

FIG. 12 is an exploded isometric view of the power bus of FIG. 11.

FIG. 13 is an exploded isometric view of a partial lead-acid electrochemical cell, module, power bus, and package according to another embodiment of the present disclosure.

FIGS. 14A and 14B are schematic diagrams depicting the copper scallops of an embodiment of the present disclosure.

FIG. 15A is an isometric view of a partial lead-acid electrochemical cell module, power bus, and package according to another embodiment of the present disclosure.

FIG. 15B is a side view of a partial cell of FIG. 15A.

FIG. 16 is a schematic diagram of a mono-directional grid substrate of an embodiment of the present disclosure.

FIG. 17 is graph the power as a function of energy for certain embodiments of the present disclosure

FIG. 18 is a graph of power as a function of energy depicting the range of energy and power that has been achieved by prior known lead-acid batteries, along with a linear trendline describing the line of best fit to the points depicted in FIG. 5, as well as certain embodiments of the present disclosure depicted above the trendline.

FIG. 19 is a graph of power as a function of energy depicting the range of energy and power that has been achieved by prior known lead-acid batteries, along with a linear trendline describing the line of best fit to the points depicted in FIG. 5, and a second trendline translated to the position of a prior known lead acid battery sample tested, a third trendline depicting specific power at 620 Wh/kg, and certain embodiments of the present disclosure above the trendlines.

### DETAILED DESCRIPTION

Reference will now be made in detail to exemplary embodiments of the present disclosure, examples of which are illustrated in the accompanying drawings. Wherever possible, the same reference numbers will be used throughout the drawings to refer to the same or like parts.

The determination of power and energy is not standardized in the field of electromechanical energy storage and conversion devices. Although various measurement standards have been employed for certain electrochemistries, they may not be applicable to others. Various manufacturers often fail to disclose precisely how power and energy were determined, making it difficult to determine whether or not the reported values are valid under other measurement methods. Thus, claims of specific levels of power and energy may be inconsistent and may in some cases not be reproducible if measured under a different standard.

Power and energy are often measured using 2 second and/or 10 second pulses, at 100%, 80%, and/or 50% state-of-charge. These measurements are typically made at ambient temperatures (c. 25° C.). Unless specified otherwise, the measured values reported in this disclosure for the embodiments of the disclosure were measured using this method.

An embodiment of the disclosure is an electrochemical storage device, comprising one or more lead-acid electrochemical cells; said device having a specific energy greater than or equal to about 10 Watt-hours/kilogram and less than or equal to about 80 Watt-hours/kilogram. In some embodiments, the device has specific power greater than or equal to 600 W/kg. Additionally, the device may have cycle life greater than or equal to about 150 cycles. A further embodiment of the present disclosure may comprise an electrochemical storage device, further comprising: one or more lead-acid electrochemical cells; and said device is adapted to operate between about −30° and about 80° C.

Specific energy may be measured by one of more of the following methods: for a 2-second pulse at 100% state-of-charge; for a 10-second pulse at 100% state-of-charge; for a 2-second pulse at 80% state-of-charge; for a 10-second pulse at 80% state-of-charge; for a 2-second pulse at 50% state-of-charge; for a 10-second pulse at 50% state-of-charge. Energy and power may be determined by any combination of these methods, as well as by other measurement techniques that may be generally accepted in the scientific community to determine specific energy and/or specific power.

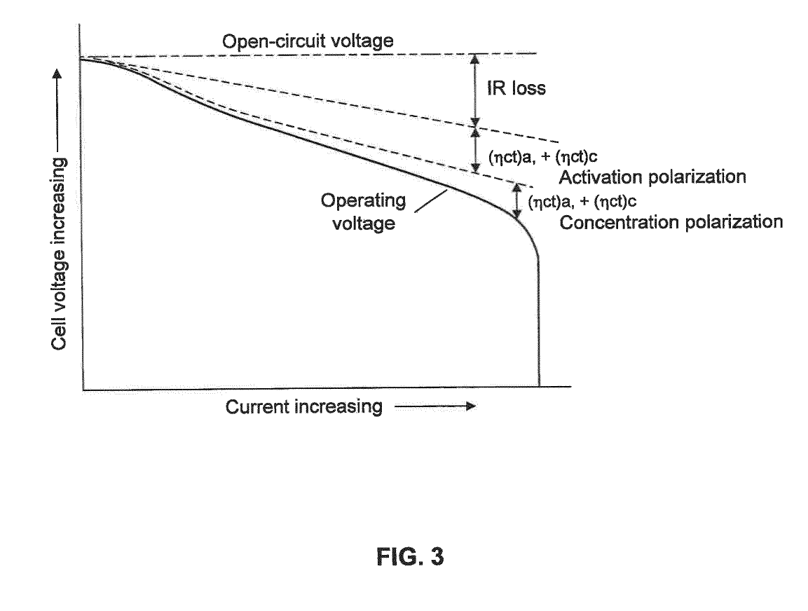

Not wishing to be bound by theory, various embodiments of the present disclosure achieve improvements in the specific power and/or specific energy of lead-acid batteries by reducing the internal resistance of the electrochemical cell. Specifically, as depicted in FIG. 3, resistance is primarily a function of three factors: internal resistance; activation; and mass transport. See Reddy, Thomas D., ed., LINDEN'S HANDBOOK OF BATTERIES, at 2.2-2.3, McGraw-Hill, New York, N.Y. (4^{th} ed. 2011). FIG. 3 depicts the relative influence of these several factors, including internal resistance (“IR loss”), activation (“activation polarization”), and mass transport (“concentration polarization”).

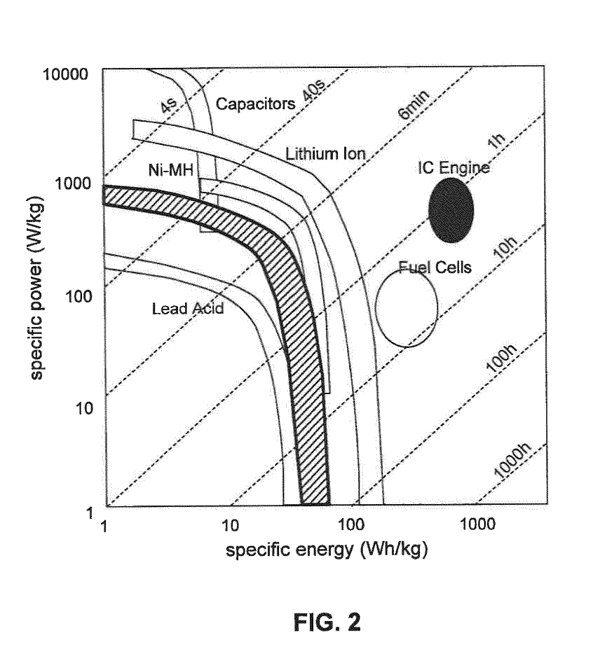

The internal resistance of the lead-acid electrochemical cell may, in turn, be a function of several additional factors, which include grid, grid-to-end-terminal connections, inter-terminal connections, and end-terminal connections. By reducing the resistances of these components, various embodiments have achieved improved specific power and specific energy relative to prior known lead-acid electrochemical cells and batteries. In particular, various advances that have contributed to improved specific power and specific energy, in accordance with this disclosure, include: end plate connection, bus bar, and aspect ratio of plates. By making these improvements, embodiments of electrochemical cells of the present disclosure have achieved specific powers exceeding 855 W/kg, which are well in excess of the 525 W/kg specific power of a benchmark lead-acid electrochemical cell. Embodiments of the present disclosure have achieved improved results as shown by the cross-hatched area on FIG. 2, well in excess of prior know lead-acid designs.

Various embodiments make a number of improvements to reduce internal resistance: increased conductivity of grid wires; coating on grid wires; aspect ratio—reduce root mean square distance between active material and current collector and between current collector and tabs; bi-polar structure; active material; pick-up plate to bus bar; bus bar current collector to terminal; active material contact to grid; saturation of separators; compression of electrode stack (separator); and thin plates which provide increased surface area and improve contact with grid wires.

Various embodiments take a number of steps to improve activation: surface area of the active material; chemical composition of the active material; and use of various additives.

Various embodiments have improved concentration polarization (mass transport) through the improvement of pore shape, size, and volume; increased pore size; and increased surface area.

The present inventors have evaluated a number of commercially-available, Absorbent Glass Mat (AGM) Sealed Recombinant, Valve Regulated Lead-Acid (VLRA) batteries. Jay, The Horizon Valve Regulated Lead Acid Battery-Reengineering the Lead-Acid Battery, IEEE (1996), discloses certain details of the Horizon® advanced lead-acid battery. Using composite lead-fiberglass wires instead of traditional substrate materials, Jay claims specific power of 250 W/kg and specific energy of 50 Wh/kg. Yet, Jay reports further that these lead-acid batteries exhibited a one-hour cycle life of only 400 cycles at 100% depth-of-discharge. Extreme Power advertises 4 kWhr energy and 10 kW power based on the Horizon lead-fiberglass composite design.

It has been reported that the Horizon battery was tested for electric vehicle use in a Chrysler T-Van. Horizon reports that the battery delivered a specific energy of 44 Wh/Kg, and a specific power of 300 W/Kg, for 280 Dynamic Stress Test (DST) cycles. The DST Test is specified by the U.S. Advanced Battery Consortium (USABC) to simulate typical urban driving profiles. In this DST test, the module is charged and discharged at various power levels so that the system will draw enough current (and cause differing amounts of cell voltage) to sustain the specified power load. The module is cycled for a fixed number of cycles or until limits on temperature, voltage, current, or step time or number of cycles are reached. Eleventh Annual Battery Conference on Applications and Advances, (1996) at 159-162, IEEE digital identifier: 10.1109/BCAA.1996.484987, the entire contents of which are incorporated herein by reference.

Xtreme Power makes a bi-polar VRLA battery for an uninterruptible power supply. The XP battery is used for emergency back-up power and remote AC power supply. Applicants have purchased a new Remote AC Power Supply including four 12 V, 85 Ahr XP lead-acid batteries. Xtreme reports that this battery delivers 50 Wh/kg and 250 W/kg.

### COMPARATIVE EXAMPLES

The present inventors tested samples of prior know batteries and examples of embodiments of the present disclosure which are reported herein in the same manner, namely, the measurements are normalized to a 2 sec. pulse, at 100% state-of-charge, at ambient temperature (c. 25° C.).

### Example 1

### Xtreme Power

Applicants have tested the Xtreme Power batteries sold as part of a welding power supply. Two of the batteries failed within the first ten cycles. One of the remaining batteries delivered 36.1 Wh/kg (specific energy) and 521 W/kg (specific power), and a second 39.5 Wh/kg and 271 W/kg.

TABLE 2
Xtreme Power AGM, VRLA Battery
Specific Energy and Specific Power Test Results

| Sample | Specific Energy (Wh/kg) | Specific Power (W/kg) |
|---|---|---|
| SKD 2 | 36.1 | 521 |
| SKD 3 | 39.6 | 592 |
| SKD 4 | 39.5 | 271 |

### Example 2

### Varta

Discover makes a sealed AGM, VRLA battery for general purpose power supply applications. Applicants purchased two Discover 12 V, 70 Ahr AGM VRLA batteries, Model No. EV34A and one 12 V, 65 Ahr AGM VRLA battery, Model No. EV34A-A. Applicants tested three Discover batteries and found that one unit delivered 36.6 Wh/kg (specific energy) and 183 W/kg (specific power). A second unit delivered 40 Wh/kg (specific energy) and 202 W/kg (specific power). A third unit delivered 39 Wh/kg (specific energy) and 198 W/kg (specific power). The values reported in Table 3 are the best measured values for each of the cells.

TABLE 3
Discover AGM, VRLA Battery
Specific Energy and Specific Power Test Results

| Sample | Specific Energy (Wh/kg) | Specific Power (W/kg) |
|---|---|---|
| EV34AA-1 | 36.6 | 183 |
| EV34A-1 | 40 | 202 |
| EV34A-2 | 39 | 198 |

### Example 3

Varta makes an AGM VRLA battery for SLI applications. Applicants acquired a Varta Model E39, 12 V, 70 Ahr, 760 A for Start/Stop applications. The Varta battery is used in the Ford Fusion. Applicants acquired four units and tested for power and energy using a 2 sec. pulse at 100% state-of-charge. Three of the Varta batteries failed within 50 cycles during cycle-life testing before they were tested for power and energy. The value shown in Table 4 is the best measured value for the Varta battery.

TABLE 4
Varta AGM, VRLA Stop/Start Battery
Specific Energy and Specific Power Test Results

| Sample | Specific Energy (Wh/kg) | Specific Power (W/kg) |
|---|---|---|
| E39 HOA109112 0336 | — | — |
| E39 HOA109112 0305 | 37.9 | 433.5 |
| E39 HOA109112 0555 | — | — |
| E39 HOA109112 0332 | — | — |

### Example 4

### Enersys

Enersys makes an AGM VRLA 12V, 92 Ahr rated, thin plate lead-acid battery for use as an uninterruptible power supply. Applicants acquired four Enersys Model SBS C11 batteries. Applicants tested the Enersys batteries using the 2 sec. pulse at 100% state-of-charge. Applicants found that Sample 1 delivered 37.5 Wh/kg and 187.7 W/kg. Sample 2 delivered 37.4 Wh/kg and 187 W/kg. Sample 3 delivered 37.8 Wh/kg and 188.7 W/kg. The values shown in Table 5 are the best measured values for the Enersys batteries.

TABLE 5
Enersys AGM, VRLA UPS Battery
Specific Energy and Specific Power Test Results

| Sample | Specific Energy (Wh/kg) | Specific Power (W/kg) |
|---|---|---|
| 1110D121040267 | 37.5 | 187.7 |
| 1110D121040242 | 37.4 | 187 |
| 1110D121040240 | 37.8 | 188.7 |

### Example 5

### Concorde

Concorde made a 12V, 33 Ahr, AGM, VRLA airplane turbine-starter battery that is designed for military use. Applicants bought two Concorde RG-35AXC batteries and tested them according to the 2 sec. testing protocol disclosed in this application. One delivered 25.4 Wh/kg (specific energy) and 614.7 W/kg (specific power). The second unit delivered 25.6 Wh/kg (specific energy) and 619.5 W/kg (specific power). Of the five batteries tested, Concorde delivered the highest specific power but the lowest specific energy. Applicants believe that this is due to the provision of substantial amount of lead in the grids to carry current, which facilitates the high power levels. The values shown in Table 6 are the best measured values for the Concorde batteries.

TABLE 6
Concorde AGM, VRLA UPS Battery
Specific Energy and Specific Power Test Results

| Sample | Specific Energy Wh/kg | Specific Power W/kg |
|---|---|---|
| 40533753 | 25.4 | 614.7 |
| 40533747 | 25.6 | 619.5 |

Lead-acid batteries are also manufactured by Optima and Johnson Controls (JCI) (Sears DieHard™). Optima is a starter battery. The Optima battery has unacceptably short life and does not withstand the testing protocol disclosed in this application. The present inventors have not yet tested the JCI Sear Die-Hard battery.

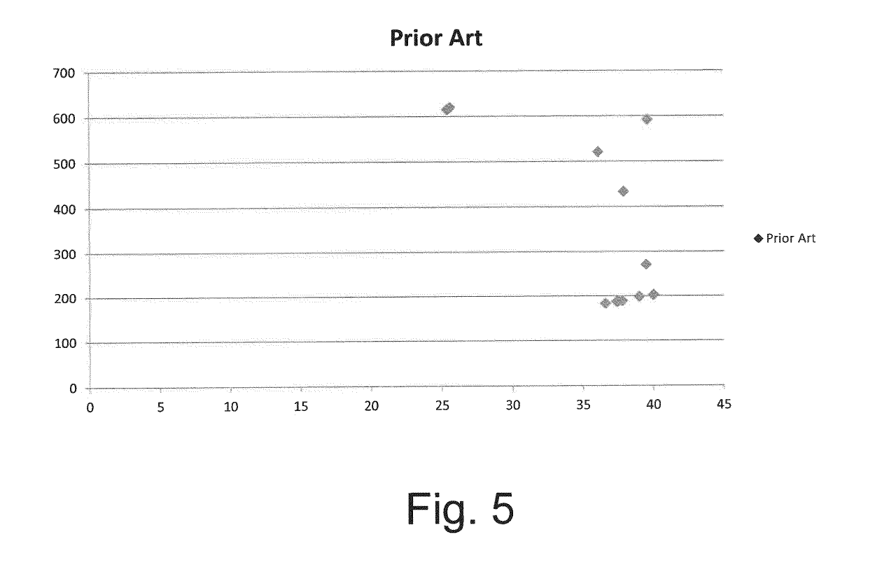

As shown by the data above and depicted graphically on FIG. 5, prior known lead-acid batteries have achieved a maximum attainable specific energy of about 40 Wh/kg, while providing a peak specific power density of about 600 W/Kg. Even allowing for improvement in the design of these prior known cells, the maximum attainable by prior art designs appears to be specific energy of about 44 Wh/kg, while providing a peak specific power density of about 202 W/Kg.

In general, power is a logarithmic function of energy. The relationship takes the general form:

P=log(−E) (Equation 1)

Where:

P=specific power (W/kg); and

E=specific energy (Wh/kg).

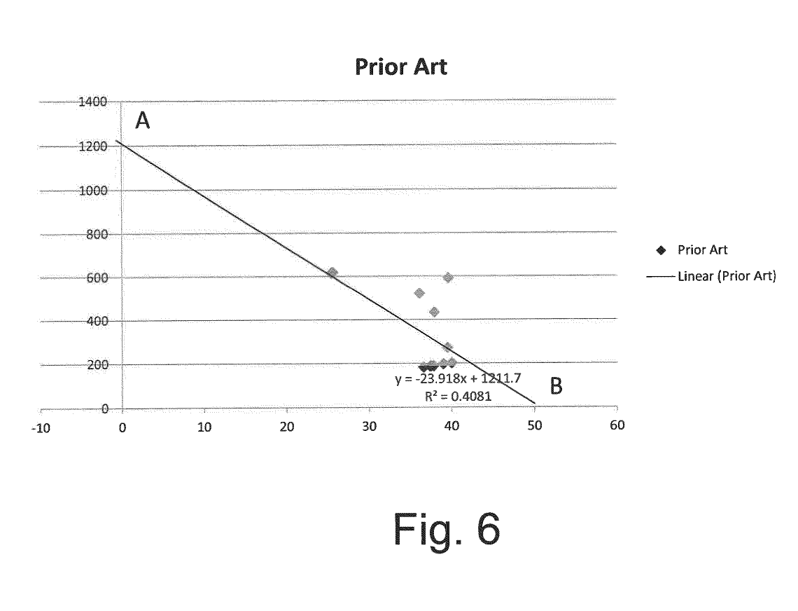

Generally, there is a trade-off between specific power and specific energy. FIG. 6 depicts this trade-off graphically for the prior known lead-acid batteries tested by Applicants. Traditionally, the trade-off between power and energy defines the arc of an ellipse on a Ragone plot.

A logarithmic function of this type is complex to analyze and may be difficult to conceptualize. A series of alternative mathematical expressions have been identified that approximate the space on a graph of power as a function of energy that is defined by the logarithmic function defined by Equation 1.

Specific power may be estimated as a function of specific energy for the prior known samples as a straight line or trendline. This combination of energy density and power density is shown in FIG. 6 as a trendline A-B, expressing the relationship:

P=−23.918E+1211.7 (Equation 2)

Further simplifying the expression of Equation 2, Equation 3 approximates the trendline fitting the above-measured samples by the expression:

P≧c.1212−24E (Equation 3)

### Where:

P=specific power (W/kg); and

E=specific energy (Wh/kg).

and c. stands for circa. Equation (5), therefore, indicates that P is greater than or equal to about 1212 minus 24 times E.

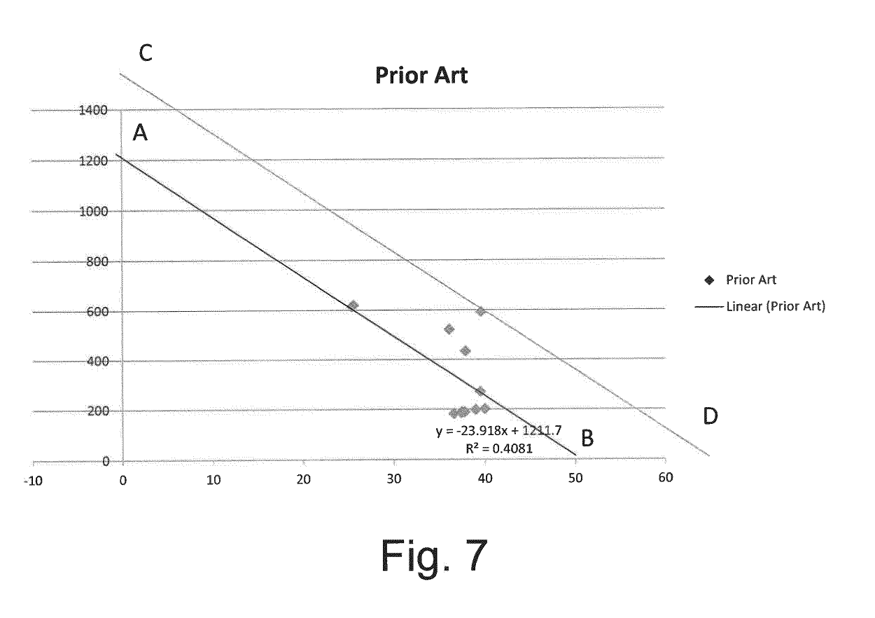

The trendline A-B in FIG. 6 has been translated upward and to the right in FIG. 7 to intercept the data point of the prior known samples that exhibits the combination of the highest energy and power C-D. A margin above the measured data point may be provided to account for measurement error bars and error propagation through averages. This results in a translated trendline characterized by the following expression:

P=1538.4-23.918E (Equation 4)

Simplifying the expression of Equation 4, Equation 5 approximates the trendline fitting the above-measured samples by the expression:

P≧1540−24E (Equation 5)

Where:

P=specific power (W/kg); and

E=specific energy (Wh/kg).

The portion of the graph above and to the right of translated trendline C-D on FIG. 7 represents combinations of energy and power that have not been attainable by prior known batteries. In addition, the known lead-acid prior batteries have been unable to achieve specific power levels in excess of 620 W/kg (represented by Line E-F on FIG. 7B) defined by the expression:

P≧620 W/kg (Equation 6)

Where: P=specific power (W/kg).

Providing an additional margin to account for measurement error bars, the expression of Equation 6 may be simplified as P≧650 W/kg. Thus, the prior known lead-acid batteries have been unable to achieve the combination of specific power and energy characterized by the expressions:

P≧c.1540−24E (Equation 5)

or

P≧650 W/kg (Equation 7)

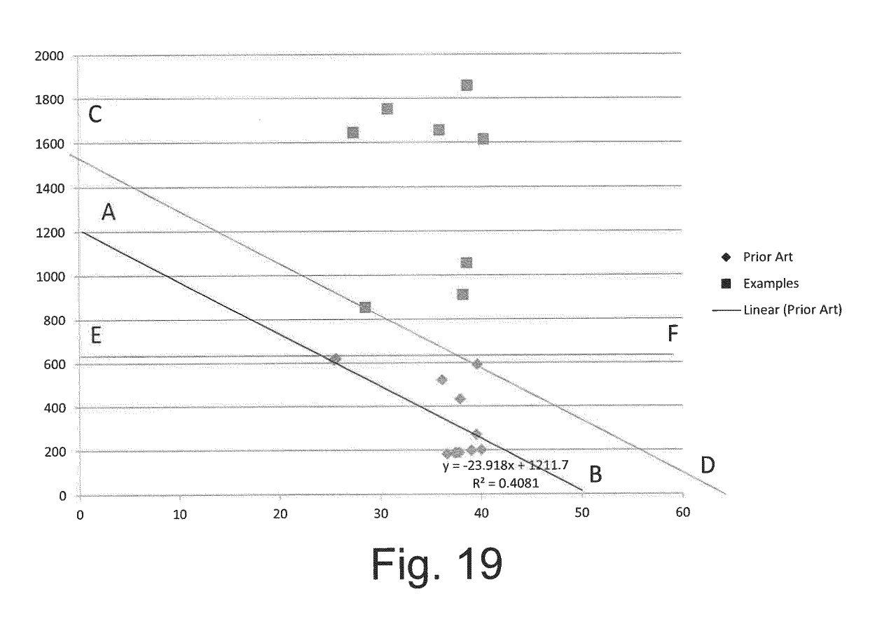

The region above and to the right of trendline C-D on FIG. 7 or 19 or above trendline E-F on FIG. 19 represents combinations of specific power and specific energy that are unattainable with prior known lead-acid electrochemical storage devices.

Various existing lead-acid devices are designed for extremely specialized applications in which cycle-life, or one or more other parameters that may be considered important for hybrid vehicle or stationary power applications was compromised. Such extremely low energy, low power, or low-cycle life electrochemical storage devices are generally not suitable for vehicle motive power applications, specifically for stop/start, partial electrification of the drive train, or full electrification of the drive train, where longer cycle-life is demanded.

### EXAMPLES

Embodiments of the present disclosure achieve substantially higher specific power and specific energy than prior know lead-acid designs. Relative to these known lead-acid batteries, various embodiments introduce a number of improvements in the design of lead-acid electrochemical storage cells. These include: thin electrodes; current flow direction grid; thin separators; alloy grids; improved active materials; compression of the electrode stack; low impedance bus bar; lower pressure valve; improved separators; improved sealing; and grid coatings.

In addition, improvements of the present disclosure provide a lead-acid battery that offers cycle-life suitable for use in transportation motive power applications. Specifically, for vehicle use, lead acid batteries must maintain good performance over repeated cycles. In various embodiments, a minimum requirement would be over about 650 cycles. Cycle-life is heavily dependent on depth-of-discharge. For example, for microhybrid applications, the battery may cycle frequently but only at a minimal (5%) depth-of-discharge. A full-electric drive on the other hand would require 100% depth-of-discharge, yet, at a slower rate, and for fewer cycles. Lead-acid cells of various embodiments would maintain good performance characteristics over thousands of cycles.

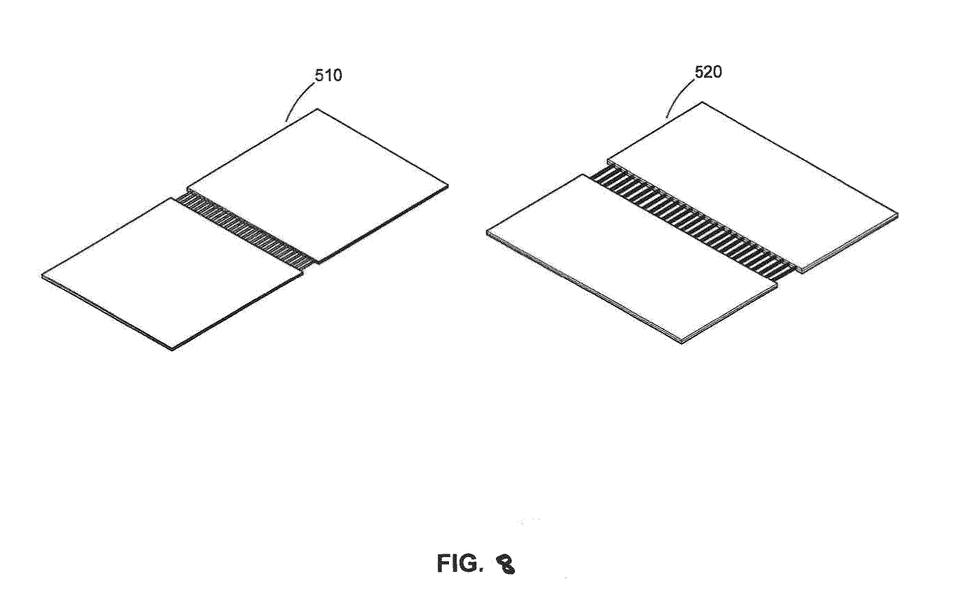

According to some embodiments, the aspect ratio of the electrode plates was modified. FIG. 8 shows electrode plates 510 and 520. Electrode plate 510 depicts a 4″ by 4″ electrode plate, while electrode plate 520 depict a 2″ by 4″ electrode plate. In accordance to various embodiments, modification of the aspect ratio of the electrode plates enables more efficient current collection.

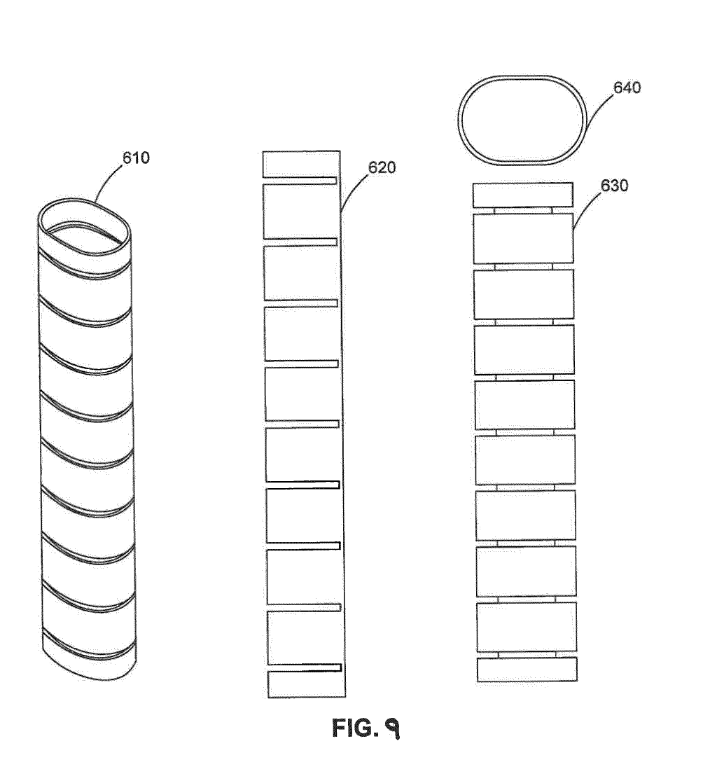

Second, the bus bar was modified in some embodiments. The benchmark design employed cast lead end plates as a bus bar. The embodiment shown in FIG. 9, on the other hand, employs a bus bar 600 made of copper tube, having a plurality of slits 610 formed therein. Each slit 610 extends part-way through copper tube 600 to receive the end caps of the electrode plate and to retain the electrode plates.

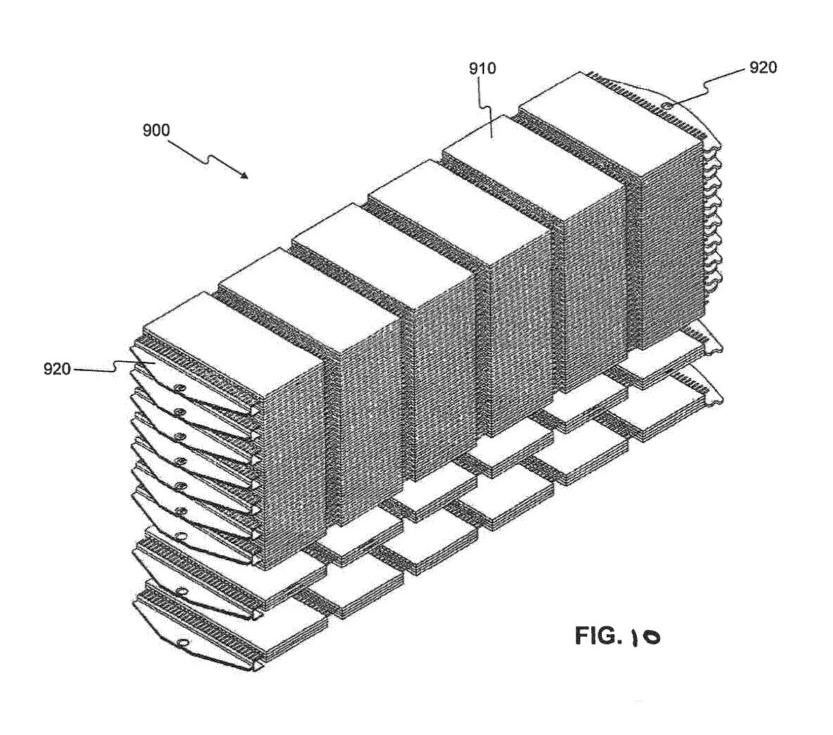

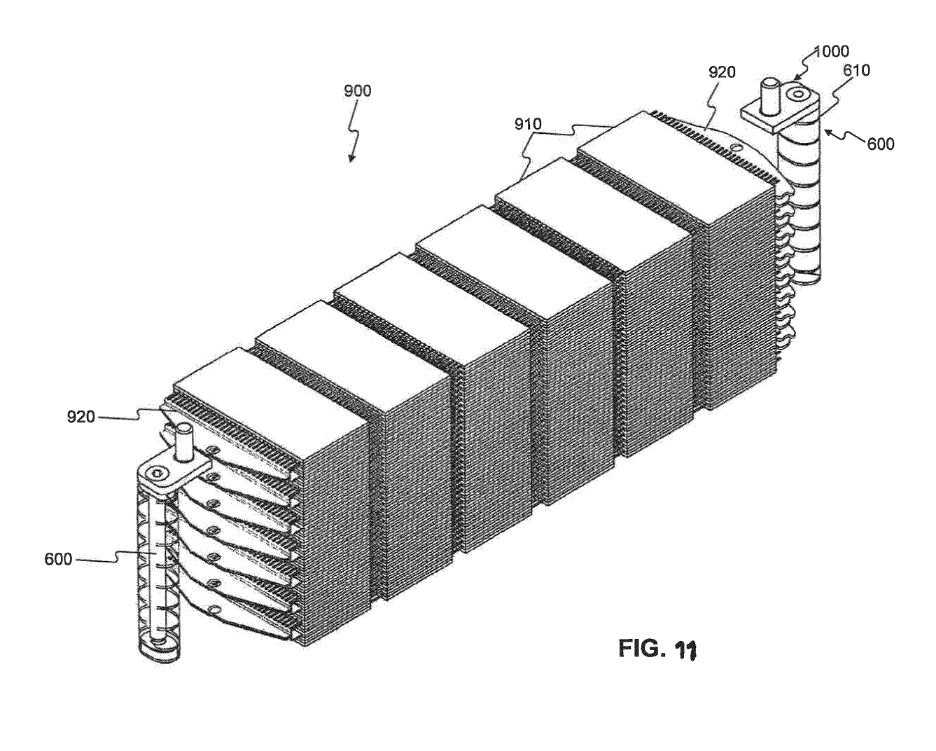

FIGS. 10 and 11 show oblique views a plate assembly 900 of electrode plates 910 according to some embodiments. The assemblies of electrode plates 910 include end caps 920. As shown in FIG. 11, end caps 920 are retained within the slits 610 in bus bar 600, which is part of a bus bar assembly 1000.

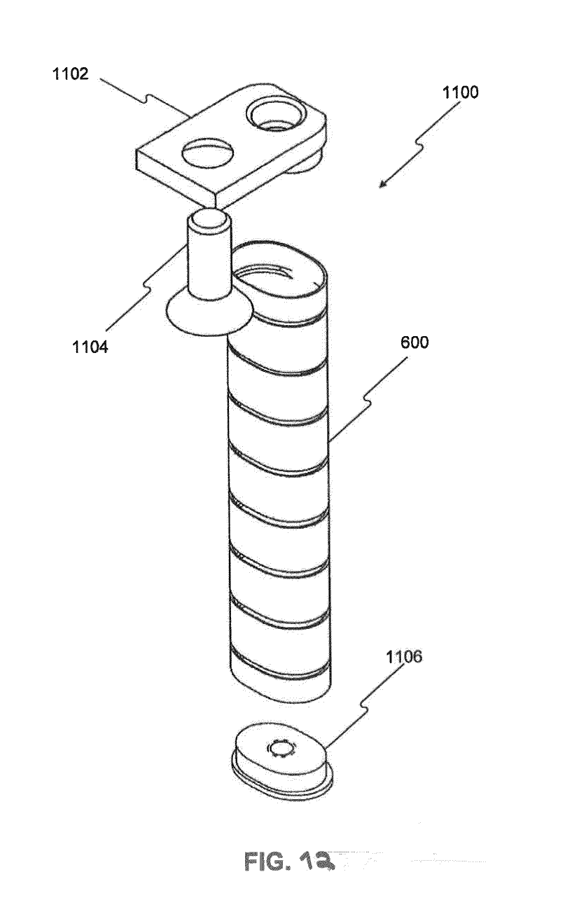

FIG. 12 depicts an exploded view of a bus bar assembly 1100, according to various embodiments. Bus bar assembly 1100 includes a bus bar 600, a connector piece 1102, a terminal 1104, and a nut 1106.

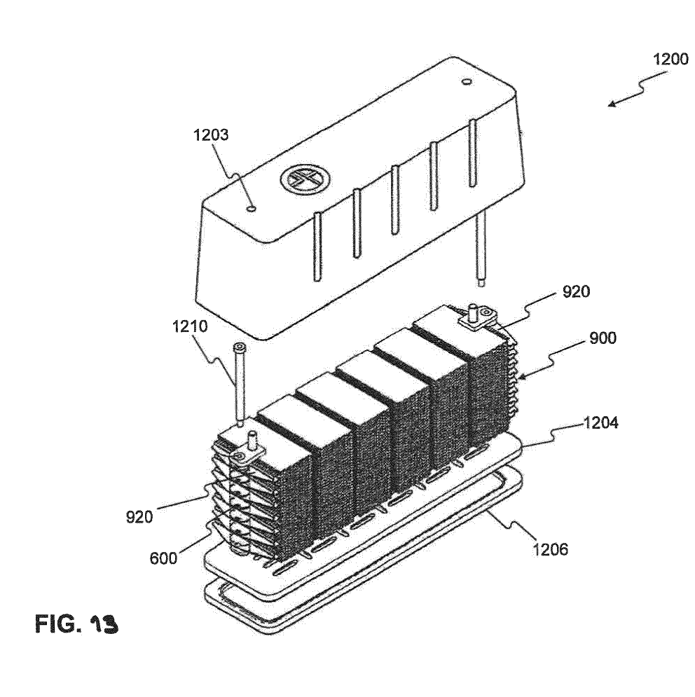

FIG. 13 illustrates a lead-acid electrochemical cell module 1200 including plate assembly 900 according to some embodiments. The lead-acid electrochemical cell module 1200 includes a casing 1203, a slotted tray 1204, a drip tray 1206, and a bolt 1210. In particular, FIG. 13 shows end caps 920 retained within the slits of bus bar 600. Further, bolt 1210 passes through the aligned holes of end caps 920 and the cavity inside bus bar 600.

### Example 1

### EM-1

Example 1, an embodiment of the present disclosure, achieves a specific power of 855 W/kg, well in excess of that of prior known designs.

For a battery of Example 1 delivering 50 kW for 2 seconds and 855 W/kg, the savings in weight is substantial. Such a battery would weigh about 58.5 kg (50,000 W/855 W/kg=58.5 kg). The battery of Example 1 delivers 1,200 Wh or 1.2 kWhr. In contrast, a benchmark battery delivering 535 W/kg weighs about 93.5 kg. A 40 Wh benchmark battery delivers 3,740 Wh, or 3.8 kWhr. Thus, the benchmark battery is about 1.5 times the weight of the battery of Example 1.

According to various embodiments, to increase the specific power the electrodes may be made thinner to improve activation and mass transport. According to some embodiments, more electrodes may be disposed in the same volume, further improving mass transport. Further, in some embodiments, improvements in the paste contribute to reducing ohmic resistance. Specifically, Solka-Floc® microfiber material may be added to the paste to reduce shrinkage and increase BET (Braun-Emmett-Teller) surface area (measured by ASTM Standard # C1274-10). The improved paste composition may improve mass transport. In addition, the fiber dissolves in contact with the electrolyte (forming CO₂ and H₂O) potentially leaving channels in the active material.

Further, according to various embodiments, improvements in the end plates, and bus bar connectors, discussed above, may further contribute to reducing the internal resistance and improving the mass transport of the improved electrochemical cell of the present disclosure.

### Example 2

### EPS40-2

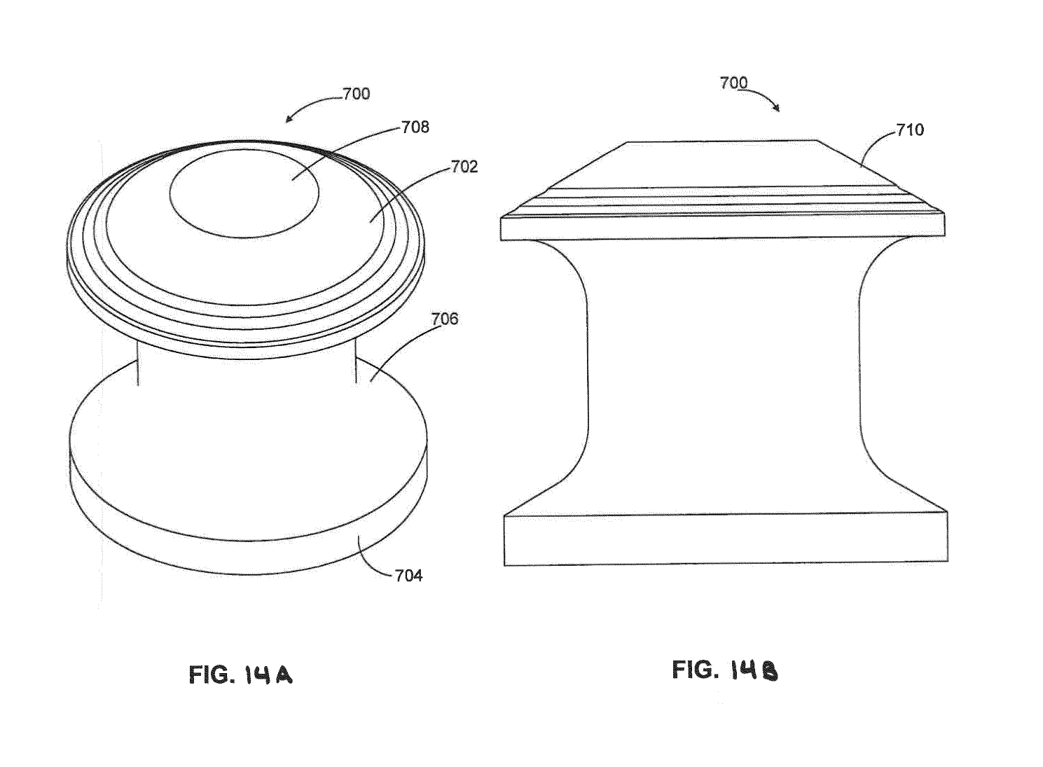

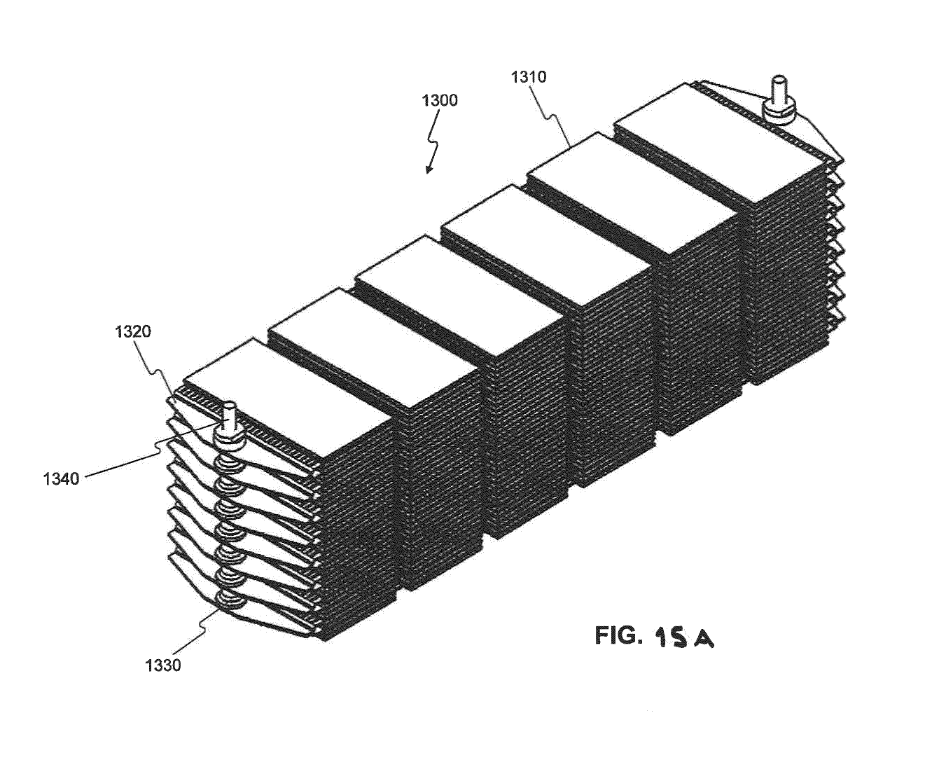

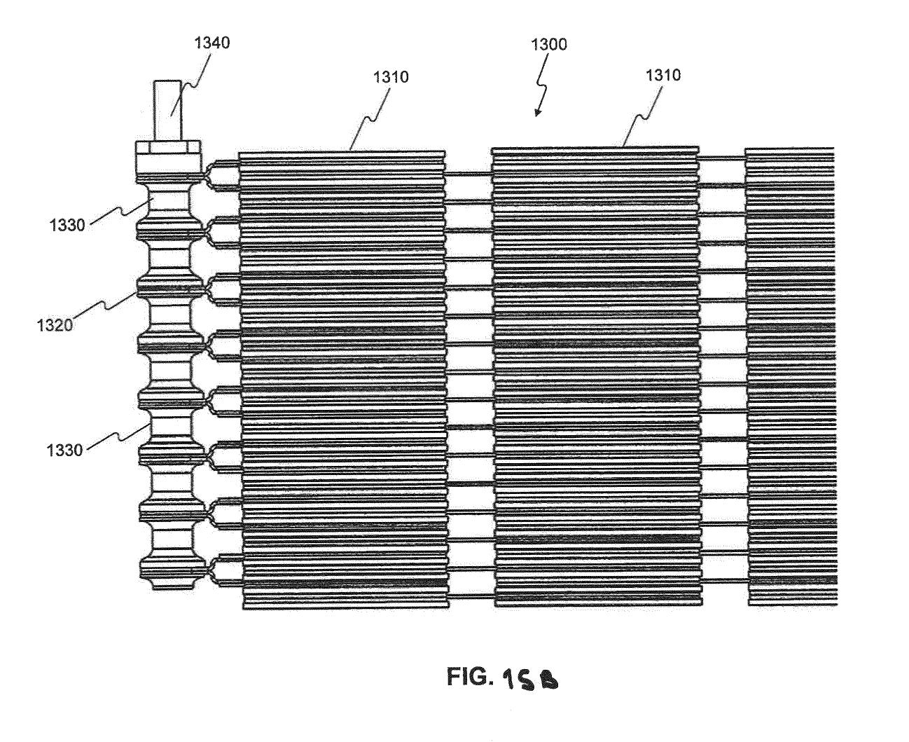

Several improvements were made over the benchmark design in accordance with embodiments of the present disclosure. The embodiment of Example 2 employs 2″×4″ electrode plates, similar to those employed in the embodiments of Example 1. Instead of the copper tube bus bar, however, copper scallops, of the type shown in FIGS. 14A and 14B, were used. FIGS. 14A and 14B show, from two different angles, a copper scallop 700, according to some embodiments. Moreover, FIGS. 15A and 15B show, from two different angles, a plate assembly 1300 using the scallops according to various embodiments.

Scallop 700 of FIGS. 14A and 14B includes upper and lower ends 702 and 704 and a stem 706 connecting those ends. Further, an opening 708 is formed in the center of scallop 700 which provides a go through channel for a bolt, according to some embodiments. In some embodiments one or both of upper and lower ends 702 and 704 are shaped to include a slanted portion 710. In some embodiments, slanted portion 710 is shaped and sized to fit inside the opening in the end caps of electrode plates, as described in relation to FIGS. 15A and 15B.

Plate assembly 1300 of FIGS. 15A and 15B includes electrode plates 1310, end caps 1320, scallops 1330 and bolt 1340. Scallops 1330 are positioned between end caps 1320 and secured in a stack to retain the end caps. In some embodiments, in the assembly, the slanted portion of upper or lower end of each scallop 1330 is fit inside the opening of the corresponding end cap 1320 to secure the end cap in place. Further, in some embodiments, when assembled, the openings in end caps 1320 and scallops 1330 line up and form a channel for bolt 1340 to go through.

Embodiments of Example 2 achieve a specific power of 940 W/kg, well in excess of that of prior known designs. For a battery of Example 2 delivering 50 kW for 2 seconds, the improved battery weighs about 53 kg (50,000 W divided by 940 W/kg=53.2 kg). Prior known batteries, on the other hand and as shown above, weigh about 93.5 kg. Thus, the weight of the benchmark battery is about 2 times that of the battery of an embodiment of Example 2. Moreover, in the improved batteries of an embodiment of Example 2, a 40 Wh battery would deliver 2,128 Wh or 2.1 kWhr.

### Example 3

### EPS-20

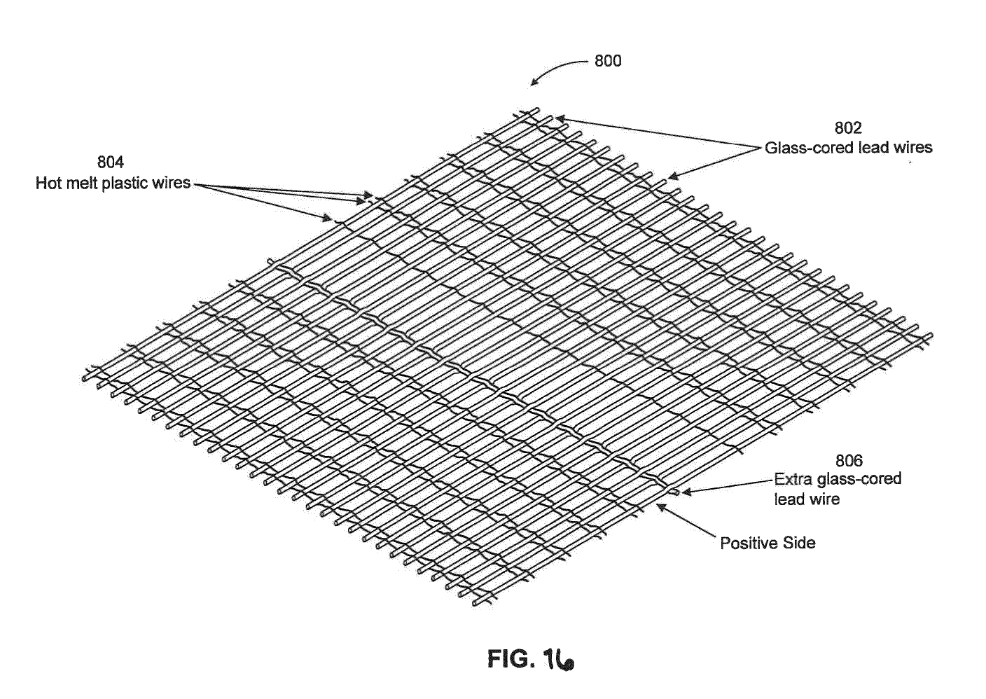

In an alternative embodiment of Example 3, the aspect ratio of the 2″×4″ electrode plates of Example 1 and scalloped copper bus bar of Example 2 were retained. The thickness of the electrodes and separator were further reduced. Moreover, in the embodiments of Example 3 the grid was aligned in the current flow direction as depicted in FIG. 16.

FIG. 16 is a schematic diagram of a mono-directional grid substrate of an embodiment of the present disclosure. FIG. 16 shows a grid 800, which includes glass-cored lead wires 802 and hot melt plastic wires 804 and 806. In FIG. 16, the directional substrate is oriented such that the glass-coated lead wires 802 run in the current flow direction, electrically connecting the positive and negative halves of the electrode plate. Specifically, the glass-cored lead wires 802 are oriented so that they run from plate to plate, electrically connecting the two plates. The grid serves as a substrate for the active material and as a current collector. These additional improvements resulted in substantially improved power. The embodiment of Example 3 achieved specific energy of 38.6 Wh·kg and specific power of 1,055.1 W/kg.

### Example 4

### EPS-21

Example 4 was made in the same batch as Example 3. In the embodiments of Example 4, the aspect ratio of the 2″×4″ electrode plates of Example 1 and scalloped copper bur bar of Example 2 were retained. The thickness of the electrodes and separator were reduced described in connection with Example 3. The grid was aligned in the current flow direction as depicted in FIG. 16. Example 4 achieved specific energy of 38.7 Wh/kg and specific power of 1857.7 W/kg.

Smaller sized cells were made employing the improvements of this embodiment (4 V and 7-8 Ahr). Test results on these smaller sized cells ranged from 1,809 W/kg to 1,906 W/kg. The results of testing on these smaller-sized cells indicates that full-sized cells would produce about 1,900 W/kg, well in excess of prior known designs.

The test modules are housed in a “boilerplate” test case as opposed to the housing of a finished battery product. The weight of the “boilerplate” test case is more than 100% of the weight of the active components. In an actual battery design the case burden of Applicant's batteries is only about 10-12% (case and terminals). Industry average case burden is about 15-25%. For purposes of the above calculations of specific power and specific energy based on test module measurements, Applicants used an average case burden (case and terminals) of 14%.

### Example 5

### EPS-22

Examples 5 and 6 were made in the same batch and sought to replicate the batteries of Examples 3 and 4. In the embodiments of Examples 5 and 6, the aspect ratio of the 2″×4″ electrode plates of Example 1 and scalloped copper bur bar of Example 2 were retained. The thickness of the electrodes and separator were slightly thicker than in Examples 3 and 4. Moreover, in the embodiments of Examples 5 and 6 the grid was aligned in the current flow direction as depicted in FIG. 16. Example 5 achieved specific energy of 35.9 Wh/kg and specific power of 1564.7 W/kg.

### Example 6

### EPS-25

Example 6 was made in the same batch as Example 5. Example 6 achieved specific energy of 40.3 Wh/kg and specific power of 1614.6 W/kg.

### Example 7

### EM-178

Further improvements were made over the benchmark design in accordance with another embodiment of the present disclosure. In the embodiments of Example 7, the aspect ratio of the 2″×4″ electrode plates of Example 1 and a dipped, lead coated copper terminal. The thickness of the electrodes and separator were further reduced. Moreover, in the embodiments of Example 7, the grid was aligned in the current flow direction as depicted in FIG. 16.

The embodiment of Example 7 achieved specific energy of 27.4 Wh/kg and specific power of 1645 W/kg. Smaller sized-cells (4 V and 7-8 Ahr) were made employing the improvements of this embodiment.

### Example 8

### EM-202

Further improvements were made over the benchmark design in accordance with another embodiment of the present disclosure. In the embodiments of Example 8, the aspect ratio of the 2″×4″ electrode plates of Example 1 and scalloped copper bus bar of Example 2 were retained. The thickness of the electrodes and separator were further reduced. Moreover, in the embodiments of Example 8, the grid was aligned in the current flow direction as depicted in FIG. 16. The embodiment of Example 8 achieved specific energy of 30.8 Wh·kg and specific power or 1751 W/kg.

Table 7 summarizes the results of these various embodiments of the present disclosure.

TABLE 7
Specific Energy and Specific Power of
Embodiments of the Present Disclosure

| Example | Specific Energy (Wh/kg) | Specific Power (W/kg) |
|---|---|---|
| EM-1 | 28.5 | 855.0 |
| EPS40-2 | 38.2 | 911.0 |
| EPS-20 | 38.6 | 1055.1 |
| EPS-21 | 38.7 | 1857.7 |
| EPS-22 | 35.9 | 1564.7 |
| EPS-25 | 40.3 | 1614.56 |
| EM-178 | 27.4 | 1645.0 |
| EM-202 | 30.82 | 1751.0 |

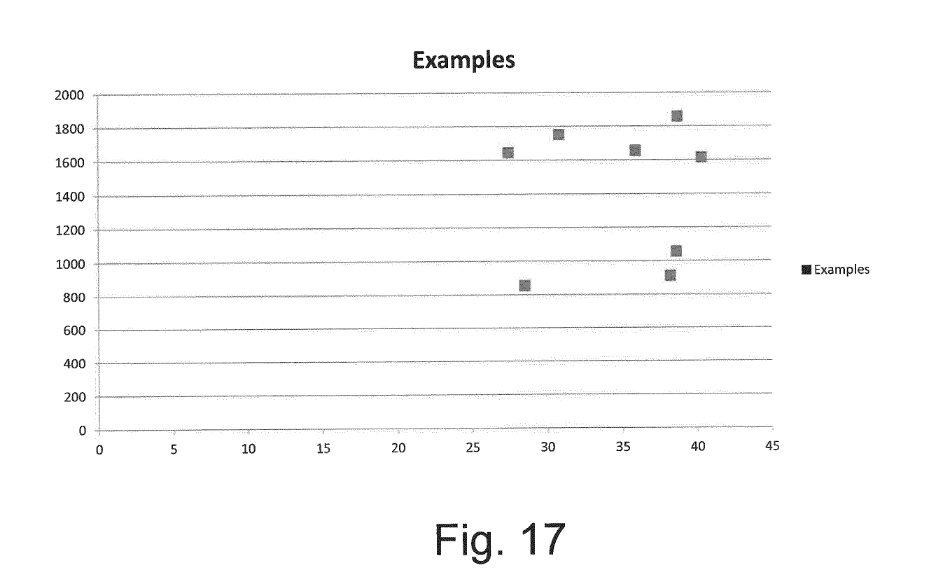

FIG. 17 depicts the results for the examples of above embodiments of the present disclosure on a graph of power as a function of energy.

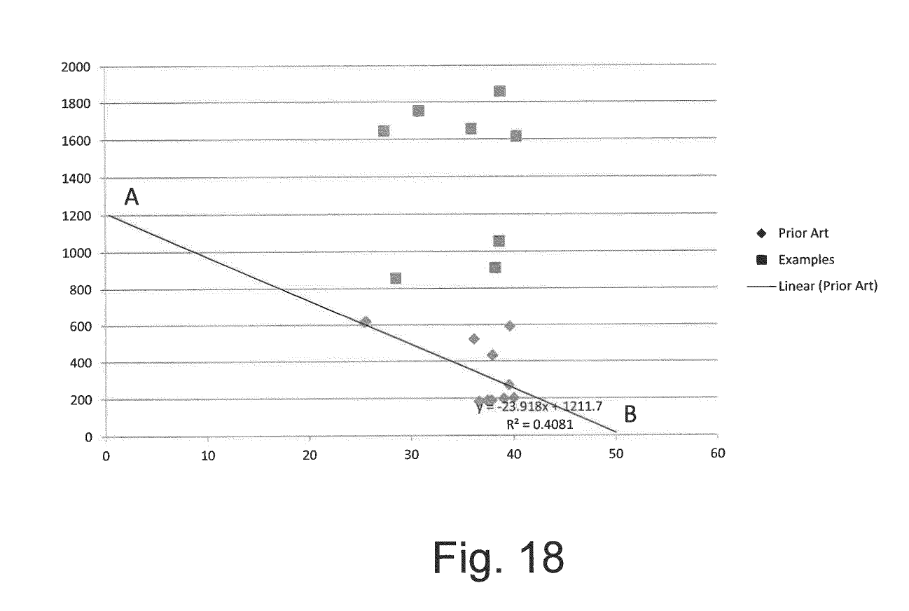

The Examples of the present disclosure each achieve higher power and energy than the best known lead-acid batteries. This is shown in FIG. 18, which displays the samples of each of the prior known samples discussed above relative to the examples of the present disclosure. As shown graphically in FIG. 19, each of the examples is above one or both of the trendlines representing the best known prior lead-acid batteries.

Embodiments of the present disclosure achieve specific power from about 620 W/kg to about 2,000 W/kg. Further, these embodiments achieve specific energy between about 20 Wh/kg and about 40 Wh/kg. Various techniques and improvements disclosed herein can produce embodiments that achieve specific power from about 620 W/kg to about 3,000 W/kg, or more, and specific energy from about 10 Wh/kg to about 80 Wh/kg, or more.

These further advances are possible through modification of the substrate and/or active material, reduction in the diameter of the wire substrate, further reduction in thickness of the electrode plates, and further improvements in the aspect ratio of the plates. Specifically, reduction in the wire diameter from about 0.028″ (28 mills) to 0.014″ (14 mills) would enable the substrate to have more wires while reducing the thickness and weight of the active material. Similarly, reducing the thickness of the plates from 0.060″ (60 mills) to 0.030″ (30 mills) would further reduce the weight of the electrochemical cell while increasing charge mobility and decreasing current density. Further, improving the aspect ratio (for example to 1:8 from 1:1 or 1:2) would enhance the efficiency of the current collector and enhance charge mobility.

Embodiments of the present disclosure are not limited to transportation and automotive applications. Embodiments of the present disclosure may be of use in any area known to those skilled in the art where use of lead-acid batteries is desired, such as stationary power uses and energy storage systems for back-up power. Further, elements or components of the various embodiments disclosed herein may be used together with other elements or components of other embodiments.

In addition to traditional lead-acid electrochemistry, other electrochemical storage systems employ lead as an active material. These include without limitation, lead-carbon, carbon-nanotubes, graphene, and various composite cathode materials. The present disclosure encompass these alternative lead-based systems.

Other embodiments of the disclosure will be apparent to those skilled in the art from consideration of the specification and practice of this disclosure. For example, various elements or components of the disclosed embodiments may be combined with other elements or components of other embodiments, as appropriate for the desired application. Thus, it is intended that the specification and examples be considered as exemplary only, with a true scope and spirit of the disclosure being indicated by the following claims.

1. An electrochemical storage device, comprising:
an electrochemical cell, wherein the electrochemical cell comprises lead in the active material;
said device having specific energy greater than or equal to about 10 Watt-hours/kilogram; and
specific power greater than or equal to about 650 W/kg.

2. The device of claim 1, further comprising:
the device having specific energy greater than or equal to a value determined by the expression:
P>1540−24E
Where:
P=specific power (W/kg); and
E=specific energy (Wh/kg).

3. The device of claim 1, further comprising cycle life greater than or equal to about 150 cycles.

4. The device of claim 2, further comprising cycle life greater than or equal to about 150 cycles.

5. The device of claim 1, further comprising said energy and power determined for a pulse characterized by a duration selected from the group consisting of 2 sec and 10 sec in duration, and a state-of-charge selected from the group consisting of 100%, 80%, and 50%.

6. The device of claim 2, further comprising said energy and power determined for a pulse characterized by a duration selected from the group consisting of 2 sec and 10 sec in duration, and a depth of discharge selected from the group consisting of 100%, 80%, and 50%.

7. An electrochemical storage device, comprising:
one or more electrochemical cells;
said electrochemical cell comprising lead in the active material;
said device having specific energy greater than or equal to about 10 Wh/kg and less than or equal to about 80 Wh/kg; and
specific power greater than or equal to about 650 W/kg and less than or equal to about 3,000 W/kg.

8. The device of claim 7, further comprising:
said device having specific energy greater than or equal to a value determined by the expression:
P>1540−24E
Where:
P=specific power (W/kg); and
E=specific energy (Wh/kg).

9. The device of claim 7, further comprising cycle life greater than or equal to about 150 cycles.

10. The device of claim 8, further comprising cycle life greater than or equal to about 150 cycles.

11. The device of claim 7, further comprising said energy and power determined for a pulse characterized by a duration selected from the group consisting of 2 sec and 10 sec in duration, and a state-of-charge selected from the group consisting of 100%, 80%, and 50%.

12. The device of claim 8, further comprising said energy and power determined for a pulse characterized by a duration selected from the group consisting of 2 sec and 10 sec in duration and a state-of-charge selected from the group consisting of 100%, 80%, and 50%.

13. The device of claim 7, further comprising two or more cells in series configuration or in parallel configuration.

14. The device of claim 7, further comprising two or more cells in parallel configuration.

15. The device of claim 9, further comprising one or more packs of cells.

16. An electrochemical storage device, comprising:
one or more electrochemical cells;
said electrochemical cell comprising lead in the active material;
said device having specific energy greater than or equal to about 20 Watt-hours/kilogram; and
specific power greater than or equal to about 850 W/kg.

17. The device of claim 16, further comprising:
said device having specific energy greater than or equal to a value determined by the expression:
P>1540-24E
Where:
P=specific power (W/kg); and
E=specific energy (Wh/kg).

18. The device of claim 16, further comprising cycle life greater than or equal to about 150 cycles.

19. The device of claim 17, further comprising cycle life greater than or equal to about 150 cycles.

20. The device of claim 16, further comprising said energy and power determined for a pulse characterized by a duration selected from the group consisting of 2 sec and 10 sec in duration, and a state-of-charge selected from the group consisting of 100%, 80%, and 50%.

21. The device of claim 17, further comprising said energy and power determined for a pulse characterized by a duration selected from the group consisting of 2 sec and 10 sec in duration, and a state-of-charge selected from the group consisting of 100%, 80%, and 50%.

22. An electrochemical storage device, comprising:
one or more electrochemical cells;
said electrochemical cell comprising lead in the active material;
said device having specific energy greater than or equal to about 20 Wh/kg and less than or equal to about 50 Wh/kg; and
specific power greater than or equal to about 850 W/kg and less than or equal to about 2,000 W/kg.

23. The device of claim 22, further comprising:
said device having specific energy greater than or equal to a value determined by the expression:
P>1540−24E
Where:
P=specific power (W/kg); and
E=specific energy (Wh/kg).

24. The device of claim 22, further comprising cycle life greater than or equal to about 150 cycles.

25. The device of claim 23, further comprising cycle life greater than or equal to about 150 cycles.

26. The device of claim 22, further comprising said energy and power determined for a pulse characterized by a duration selected from the group consisting of 2 sec and 10 sec in duration, and a state-of-charge selected from the group consisting of 100%, 80%, and 50%.

27. The device of claim 23, further comprising said energy and power determined for a pulse characterized by a duration selected from the group consisting of 2 sec and 10 sec in duration, and a state-of-charge selected from the group consisting of 100%, 80%, or 50%.
